(19) United States
(12) Patent Application Publication
(10) Pub. No.: US 2021/0311498 A1
(43) Pub. Date: Oct. 7, 2021

(54) OPERATION MANAGEMENT DEVICE, OPERATION MANAGEMENT METHOD, AND TRANSPORTATION SYSTEM

(71) Applicants: TOYOTA JIDOSHA KABUSHIKI KAISHA, Toyota-shi (JP); DENSO CORPORATION, Kariya-city (JP)

(72) Inventors: Kenji OKAZAKI, Toyota-shi (JP); Hiroshi HIGASHIDE, Toyota-shi (JP); Keiichi UNO, Kariya-city (JP)

(73) Assignees: TOYOTA JIDOSHA KABUSHIKI KAISHA, Toyota-shi (JP); DENSO CORPORATION, Kariya-city (JP)

(21) Appl. No.: 17/214,054

(22) Filed: Mar. 26, 2021

(30) Foreign Application Priority Data
Apr. 2, 2020 (JP) 2020-066597

(51) Int. Cl. G05D 1/02; G05D 1/00

(52) U.S. Cl. CPC G05D 1/0293; G05D 1/0088; G05D 1/0212

(57) ABSTRACT

An operation management device includes a plan generation unit that generates a travel plan for each of a plurality of vehicles constituting a fleet and traveling autonomously along a predetermined travel route, and an operation monitoring unit that acquires a delay amount of the vehicle relative to the travel plan and an operation interval of the vehicles in accordance with the travel information. The plan generation unit includes two or more solving policies for solving an interval error between the operation interval of the vehicles and a predetermined target operation interval of the vehicles. In a case of occurrence of a delay of the vehicle, the plan generation unit selects a solving policy from among two or more solving policies in accordance with at least the number of vehicles constituting the fleet, and generates the travel plan in accordance with the selected solving policy.

### CROSS REFERENCE TO RELATED APPLICATION

This application claims priority to Japanese Patent Application No. 2020-066597 filed on Apr. 2, 2020, which is incorporated herein by reference in its entirety including the specification, claims, drawings, and abstract.

### TECHNICAL FIELD

The present disclosure relates to an operation management device that manages operations of a plurality of vehicles traveling autonomously along a specified travel route, an operation management method, and a transportation system including the operation management device.

### BACKGROUND

A fleet management device for managing the operation of a plurality of vehicles has been known. For example, PATENT LITERATURE 1 discloses an operation information center that manages the operation of a plurality of buses. In PATENT LITERATURE 1, each bus transmits operation information including location information and an occupancy rate of the bus to the operation information center. According to the operation information, the operation information center determines whether to change the operation of each bus to average the congestion level of the bus and optimize the operation intervals. For example, if a bus is crowded or the trailing bus is about to catch up with the preceding bus, the preceding bus is allowed to pass through the bus stop where it has been scheduled to stop, and the trailing bus is allowed to accept passengers at the bus stop where the preceding bus had been scheduled to stop, thus averaging the congestion level and optimizing the intervals between buses.

In the technology disclosed in PATENT LITERATURE 1, however, it is expected that buses will frequently pass through bus stops where the buses are scheduled to stop to get the right operation intervals. This is likely to cause frustration among users waiting for the bus at the bus stops. As a result, PATENT LITERATURE 1 tends to cause dissatisfaction among users, and may reduce convenience of the transportation system.

Therefore, the present disclosure discloses an operation management device, an operation management method, and a transportation system to further improve convenience of the transportation system.

### CITATION LIST

Patent Literature 1: JP 2005-222144 A

### SUMMARY

An operation management device disclosed herein includes a plan generation unit that generates a travel plan for each of a plurality of vehicles that constitute a fleet and travel autonomously along a predetermined travel route, a communication device that transmits the travel plan to a vehicle handled by the travel plan and receives travel information from the vehicle indicating a traveling state of the vehicle, and an operation monitoring unit that acquires a delay amount of the vehicle relative to the travel plan and an operation interval of the vehicles in accordance with the travel information, in which the plan generation unit includes two or more solving policies for solving an interval error which is a discrepancy between the operation interval of the vehicles and a predetermined target operation interval of the vehicles, and in the case of occurrence of a delay exceeding a predetermined allowable delay amount, the plan generation unit selects a solving policy from among two or more solving policies in accordance with at least the number of vehicles that constitute the fleet, and generates the travel plan in accordance with the selected solving policy.

By selecting the solving policy in accordance with the number of vehicles, interval errors can be solved more appropriately. This effectively prevents increase in interval errors and excessively prolonged travel and waiting time to further improve the convenience of the transportation system.

The two or more solving policies include a first solving policy that solves the interval error on the travel plan without decelerating any vehicle below a standard scheduled speed, which is a standard speed that has been scheduled, and a second solving policy that solves the interval error on the travel plan by temporarily decelerating at least some of the vehicles below the standard scheduled speed.

The first solving policy can effectively prevent the prolonged travel time of the vehicles because none of the vehicles are decelerated. The second solving policy decelerates some vehicles to eliminate delays, and hence the interval errors, so that the interval errors are eliminated more reliably.

In this case, the second solving policy may further include a solving policy that solves the interval error by rescheduling the travel plan with reference to an actual position of a vehicle with the largest delay where the delay amount is maximum, and enables the vehicle with the largest delay to travel at the standard scheduled speed, while temporarily decelerating the other vehicles, except for the vehicle with the largest delay, below the standard scheduled speed.

This solving policy solves the interval error by decelerating some vehicles, so that any interval errors are eliminated in situations where vehicle acceleration is difficult.

The second solving policy may further include a solving policy that solves the interval error by rescheduling the travel plan with respect to the current travel plan to equalize the delay amount of the vehicles.

This solving policy minimizes a change in the scheduled speed of the vehicle and, accordingly, can effectively prevent the prolonged travel time of the vehicle due to deceleration and reduce any interval errors in situations where significant acceleration is difficult.

The plan generation unit may generate the travel plan according to the second solving policy when the number of vehicles is equal to or smaller than a predetermined reference number of vehicles, and generates the travel plan according to the first solving policy when the number of vehicles exceeds the reference number of vehicles.

Selecting the second solving policy that can reliably eliminate the interval error when the number of vehicles is small and the waiting time at the station is large can effectively prevent unacceptably large waiting time at the station.

The plan generation unit may also generate the travel plan according to the first solving policy when the number of vehicles is equal to or smaller than a predetermined reference number of vehicles, and may generate the travel plan according to the second solving policy when the number of vehicles exceeds the reference number of vehicles.

When the transportation demand is high and the number of vehicles is large, the delays, and thus the interval errors, are likely to increase. In such a case, selecting the second solving policy can effectively prevent the increase of the interval errors.

The communication device may receive at least one of two kinds of information: passenger information sent from the vehicle and concerning passengers of the vehicle, and waiting passenger information sent from a station terminal at a station on the travel route and concerning people waiting for the vehicle at the station, and the plan generation unit may select one of the two or more solving policies in accordance with the number of vehicles and at least one of the passenger information and the waiting passenger information.

This configuration enables a more appropriate solving policy to be selected according to the situation, thus solving the interval error more appropriately

In this case, the plan generation unit may estimate boarding and exiting time of the vehicle with the largest delay where the delay amount of the vehicle is maximum in accordance with at least one of the passenger information and the waiting passenger information, and calculate a risk of increase in delay, which is a risk that the delay may increase, in accordance with the boarding and exiting time of the vehicle and the number of vehicles, and the plan generation unit may generate the travel plan according to the first solving policy when the risk of increase in delay is equal to or smaller than a predetermined reference risk, while generating the travel plan according to the second solving policy when the risk of increase in delay is larger than the reference risk.

Selecting a solving policy in accordance with the risk of increase in delay can better solve the interval error.

An operation management method according to the present disclosure includes generating a travel plan for each of a plurality of vehicles constituting a fleet and traveling autonomously along a predetermined travel route, transmitting the travel plan to a vehicle handled by the travel plan, receiving travel information from the vehicle indicating a traveling state of the vehicle, and acquiring a delay amount of the vehicle relative to the travel plan and an operation interval of the vehicles in accordance with the travel information, in which in the case of occurrence of a delay exceeding a predetermined allowable delay amount, the operation management method selects a solving policy from among two or more solving policies for solving an interval error, which is a discrepancy between the operation interval of the vehicles and a predetermined target operation interval of the vehicles, in accordance with at least the number of vehicles constituting the fleet, and generates the travel plan in accordance with the selected solving policy.

A transportation system according to the present disclosure includes a fleet including a plurality of vehicles traveling autonomously along a predetermined travel route, and an operation management device that manages operations of the vehicles, in which the operation management device includes a plan generation unit that generates a travel plan for each of the vehicles, a communication device that transmits the travel plan to a vehicle handled by the travel plan and receives travel information from the vehicle indicating a traveling state of the vehicle, and an operation monitoring unit that acquires a delay amount of the vehicle relative to the travel plan and an operation interval of the vehicles in accordance with the travel information, and in which the plan generation unit includes two or more solving policies for solving an interval error which is a discrepancy between the operation interval of the vehicles and a predetermined target operation interval of the vehicles, and in the case of occurrence of a delay exceeding a predetermined allowable delay amount, the plan generation unit selects a solving policy from among two or more solving policies in accordance with at least the number of vehicles constituting the fleet, and generates the travel plan in accordance with the selected solving policy.

The technology disclosed herein can further improve the convenience of the transportation system.

### BRIEF DESCRIPTION OF DRAWINGS

Embodiments of the present disclosure will be described with reference to the following figures, wherein:

FIG. 1 is a conceptual diagram of a transportation system;

FIG. 2 is a block diagram of the transportation system;

FIG. 3 is a block diagram illustrating the physical configuration of an operation management device;

FIG. 4 illustrates an example of a travel plan used in the transportation system of FIG. 1;

FIG. 5 is an operation timing chart for each vehicle that travels autonomously according to the travel plan of FIG. 4;

FIG. 6 is a conceptual diagram illustrating a case where one vehicle is delayed;

FIG. 7 is a conceptual diagram of a first solving policy;

FIG. 8 is an operation timing chart of the vehicle in the case of following the first solving policy;

FIG. 9 is a conceptual diagram of a second solving policy A;

FIG. 10 illustrates an example of a recreated travel plan in the case of following the second solving policy A;

FIG. 11 is an operation timing chart of the vehicle in the case of following the second solving policy A;

FIG. 12 is a conceptual diagram of a second solving policy B;

FIG. 13 illustrates an example of a recreated travel plan according to the second solving policy B;

FIG. 14 is an operation timing chart of the vehicle in the case of following the second solving policy B;

FIG. 15 is a flowchart illustrating the process flow of a plan generation unit;

FIG. 16 is a flowchart illustrating another example of the processing flow of the plan generation unit; and

FIG. 17 is a flowchart illustrating the process flow of the plan generation unit in the case of selecting a solving policy according to a risk of increase in delay.

### DESCRIPTION OF EMBODIMENTS

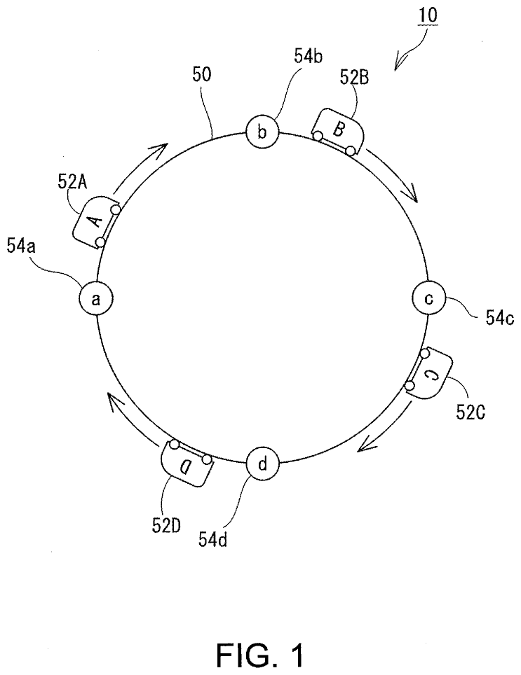

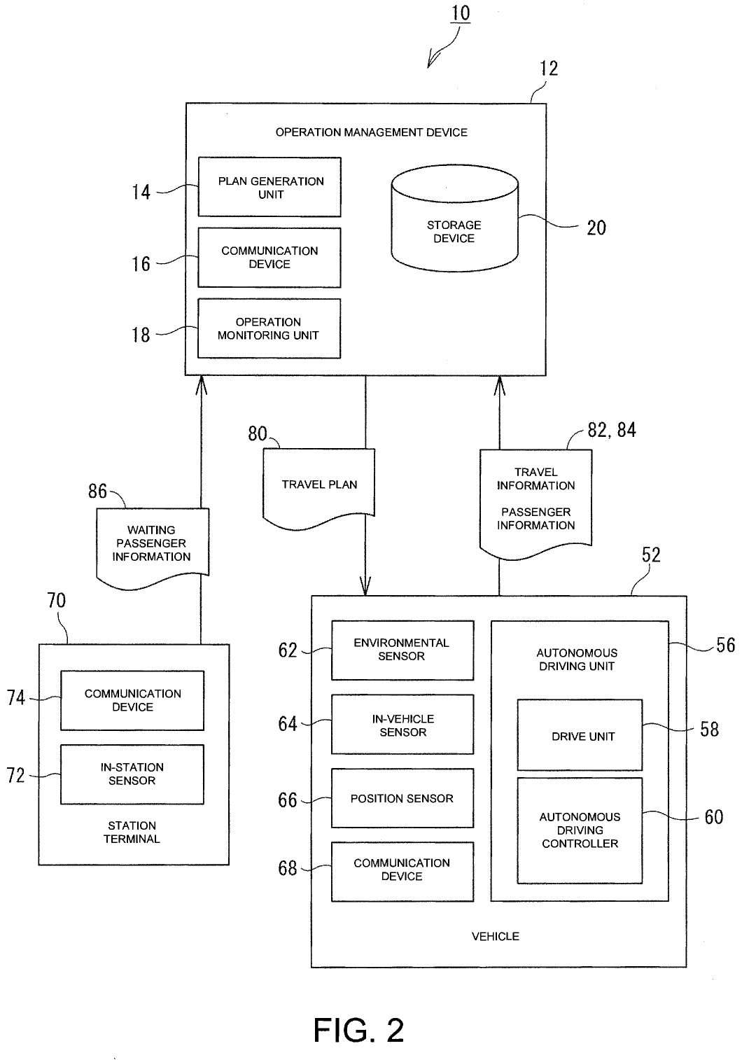

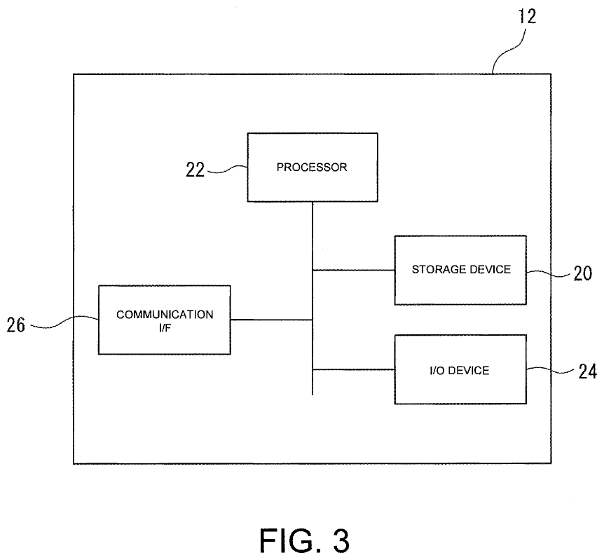

The configuration of a transportation system 10 will be described below with reference to the accompanying drawings. FIG. 1 is a conceptual diagram of the transportation system 10, and FIG. 2 is a block diagram of the transportation system 10. Furthermore, FIG. 3 is a block diagram illustrating the physical configuration of an operation management device 12.

The transportation system 10 transports an unspecified number of users along a predetermined travel route 50. The transportation system 10 includes a plurality of vehicles 52A to 52D capable of traveling autonomously along a travel route 50. A plurality of stations 54a to 54d are also set up along the travel route 50. In the following, in cases where the vehicles 52A to 52D do not need to be distinguished, the alphabetical letters next to numbers will be omitted and referred to as □vehicles 52□ Similarly, the station 54a to 54d will also be referred to as “stations 54” if there is no need to distinguish the stations.

The vehicles 52 travel around in one direction along the travel route 50, constituting a fleet. The vehicles 52 stop temporarily at each station 54. The users board or exit the vehicle 52 when vehicle 52 is temporarily stopped. Thus, in this example, each vehicle 52 functions as a passenger bus that transports an unspecified number of users from one station 54 to another station 54. The operation management device 12 (not illustrated in FIG. 1, see FIGS. 2 and 3) manages the operation of the vehicles 52. In this example, the operation management device 12 controls the operation of the vehicles 52 to achieve equal interval operation. The equal interval operation is a mode of operation in which the vehicles 52 depart each station 54 at equal departure intervals. That is, the equal interval operation is a mode of operation in which, if the departure interval at each station 54a is, for example, 5 minutes, the departure intervals at the other stations 54b, 54c, and 54d are also 5 minutes

Components that constitute the transportation system 10 will be described in more detail. The vehicles 52 travel autonomously in accordance with a travel plan 80 provided by the operation management device 12. The travel plan 80 defines a travel schedule for each vehicle 52. In this example, the travel plan 80 specifies the departure timing of the vehicles 52 at each station 54a to 54d, as will be explained in more detail later. The vehicles 52 travel autonomously to ensure departure at specified departure timing determined in the travel plan 80. In other words, all decisions regarding the speed of the vehicles between stations, stopping at traffic signals, and the need/no need to pass other vehicles are made by the vehicles 52.

As illustrated in FIG. 2, the vehicle 52 has an autonomous driving unit 56. The autonomous driving unit 56 broadly includes a drive unit 58 and an autonomous driving controller 60. The drive unit 58 is a basic unit for driving the vehicle 52 and includes, for example, a prime motor, a power transmission, a brake, a running device, a suspension device, a steering device, and the like. The autonomous driving controller 60 controls driving of the drive unit 58 and causes the vehicle 52 to run autonomously. The autonomous driving controller 60 is, for example, a computer with a processor and memory. The “computer” also includes a microcontroller that incorporates a computer system into a single integrated circuit. A processor refers to a processor in a broad sense, including a general-purpose processor (e.g., a central processing unit (CPU) or the like) and a dedicated processor (e.g., a graphics processing unit (GPU), an application specific integrated circuit (ASIC), a field programmable gate array (FPGA), a programmable logic device, or the like).

To enable autonomous driving, the vehicle 52 further includes an environmental sensor 62 and a position sensor 66. The environmental sensor 62 detects the surrounding environment of the vehicle 52, including, for example, a camera, Lidar, a millimeter wave radar, a sonar, a magnetic sensor, or the like. The autonomous driving controller 60 recognizes the type of objects in the vicinity of the vehicle 52, the distance to such objects, road surface markings (e.g., white lines and the like) on the travel route 50, and traffic signs, and the like in accordance with the detection results of the environmental sensor 62. The position sensor 66 is, for example, a global positioning system (GPS) which detects the current position of the vehicle 52. The results of the detection by the position sensor 66 are also sent to the autonomous driving controller 60. The autonomous driving controller 60 controls the acceleration, deceleration, and steering of the vehicle 52 in accordance with the detection results from the environmental sensor 62 and the position sensor 66. Such control status by the autonomous driving controller 60 is transmitted to the operation management device 12 as travel information 82. The travel information 82 includes the current position of the vehicle 52 and other information.

The vehicle 52 further includes an in-vehicle sensor 64 and a communication device 68. The in-vehicle sensor 64 detects conditions inside the vehicle 52, in particular, the number and attributes of the passengers. Attributes are characteristics that affect the boarding/exiting time of passengers, and may include, for example, at least one of the following: the use of wheelchairs, the use of white canes, the use of strollers, the use of braces, and age groups. Such an in-vehicle sensor 64 is, for example, a camera that captures images of the interior of the vehicle, a weight sensor that detects the total weight of the passengers, and the like. Information detected by the in-vehicle sensor 64 is transmitted to the operation management device 12 as passenger information 84.

The communication device 68 executes wireless communication with the operation management device 12. The communication device 68 can communicate over the Internet, for example, via a wireless local area network (LAN) such as WiFi (registered trademark) or a mobile data communication service provided by a cell phone company or the like. The communication device 68 receives the travel plan 80 from the operation management device 12 and transmits the travel information 82 and the passenger information 84 to the operation management device 12.

A station terminal 70 is provided at each station 54. The station terminal 70 has a communication device 74 and an in-station sensor 72. The in-station sensor 72 detects a state of the station 54, in particular, the number and attributes of persons waiting for the vehicle 52 at the station 54. The in-station sensor 72 is, for example, a camera that captures images of the station 54, a weight sensor that detects the total weight of the waiting people, or the like. Information detected by the in-station sensor 72 is transmitted to the operation management device 12 as waiting passenger information 86. A communication device 16 is provided to enable the transmission of the waiting passenger information 86.

The operation management device 12 monitors the operation states of the vehicles 52 and controls the operation of the vehicles 52 according to their operation states. The operation management device 12 is physically a computer including a processor 22, a storage device 20, an input/output (I/O) device 24, and a communication interface (I/F) 26, as illustrated in FIG. 3. A processor refers to a processor in a broad sense and includes a general-purpose processor (e.g., a CPU) and a dedicated processor (e.g., a GPU, an ASIC, an FPGA, a programmable logic device, or the like). The storage device 20 may also include at least one of a semiconductor memory (e.g., a random access memory (RAM), a read-only memory (ROM), solid state drive, or the like) and a magnetic disk (e.g., hard disk drive and the like). Although the operation management device 12 is illustrated in FIG. 3 as a single computer, the operation management device 12 may include a plurality of physically separated computers.

The operation management device 12 functionally includes a plan generation unit 14, a communication device 16, an operation monitoring unit 18, and the storage device 20, as illustrated in FIG. 2. The plan generation unit 14 generates the travel plan 80 for each of the vehicles 52. In addition, the plan generation unit 14 determines whether to add new a vehicle 52 to the fleet and whether to reduce the number of the vehicles 52 of the fleet according to a transportation demand and other factors. If it is determined that an increase or reduction of vehicles is necessary, the plan generation unit 14 generates another travel plan 80 that directs an increase or reduction of vehicles. Accordingly, the number of vehicles 52 traveling on the travel route 50 changes depending on the situation.

If the vehicle 52 is delayed relative to the travel plan 80, the actual operation interval of the vehicle 52 deviates from a predetermined target operation interval. The plan generation unit 14 includes two or more kinds of solving policies for solving an interval error, which is a discrepancy between the actual operation interval and the target operation interval. If the vehicle 52 is delayed more than a certain amount with respect to the travel plan 80, the plan generation unit 14 regenerates the travel plan 80 in accordance with a selected one solving policy, which will be described later.

The communication device 16 executes wireless communication with the vehicle 52 and is capable of Internet communication, for example, using WiFi or mobile data communication. The communication device 16 transmits the travel plan 80 generated and regenerated by the plan generation unit 14 to the vehicles 52, and receives the travel information 82 and the passenger information 84 from the vehicles 52 and the waiting passenger information 86 from the station terminals 70, respectively.

The operation monitoring unit 18 obtains the operation states of the vehicles 52 in accordance with the travel information 82 transmitted from each vehicle 52. The travel information 82 includes the current position of the vehicles 52, as described above. The operation monitoring unit 18 compares the position of each vehicle 52 with the travel plan 80 and calculates a delay amount DL of the vehicle 52 with respect to the travel plan 80. The delay amount DL may be a difference in distance between the target position and the actual position of the vehicles 52, or may be a difference in time between the target time to reach a specific point and the actual arrival time. The delay amount DL may be obtained at regular time intervals (e.g., every minute) or at the time when a specific event occurs. In this case, the event may be, for example, that the vehicle 52 departs a particular station 54. The operation monitoring unit 18 also calculates operation intervals of the plurality of vehicles 52 in accordance with the position of each vehicle 52. The operation interval calculated here may be a time interval or a distance interval

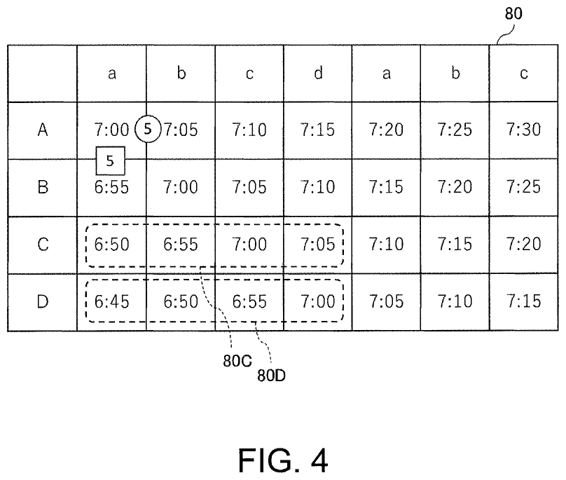

Next, the generation of such a travel plan 80 in the operation management device 12 will be described in detail. FIG. 4 illustrates an example of the travel plan 80 used in the transportation system 10 of FIG. 1. In the example of FIG. 1, the fleet consists of four vehicles 52A to 52D, with four stations 54a to 54d equally spaced on the travel route 50. In this example, the time required for each vehicle 52 to run a lap around the travel route 50, i.e., a lap time TC, is assumed to be 20 minutes.

In this case, the operation management device 12 generates the travel plan 80 so that the departure interval of the vehicles 52 at each station 54 can be 20/4=5 minutes, which is the time calculated by dividing the lap time TC by the number of the vehicles 52, N. The travel plan 80 only records the departure time at each station 54, as illustrated in FIG. 4. For example, a travel plan 80D, which is sent to the vehicle 52D, records the target time at which the vehicle 52D departs each of the stations 54a to 54d.

In addition, the travel plan 80 usually contains only a time schedule for one lap, which is sent from the operation management device 12 to the vehicle 52 at the time when each vehicle 52 reaches a particular station, e.g., the station 54a. For example, the vehicle 52C receives the travel plan 80C for one lap from the operation management device 12 at the time of reaching the station 54a (e.g., 6:50), and the vehicle 52D receives the travel plan 80D for one lap from the operation management device 12 at the time of reaching the station 54a (e.g., 6:45). However, if the travel plan 80 is modified due to a delay of the vehicle 52 or the like, the new travel plan 80 is transmitted from the operation management device 12 to the vehicle 52, even if the vehicle 52 has not reached the station 54a. If the vehicle 52 receives the new travel plan 80, it discards the previous travel plan 80 and travels autonomously in accordance with the new travel plan 80

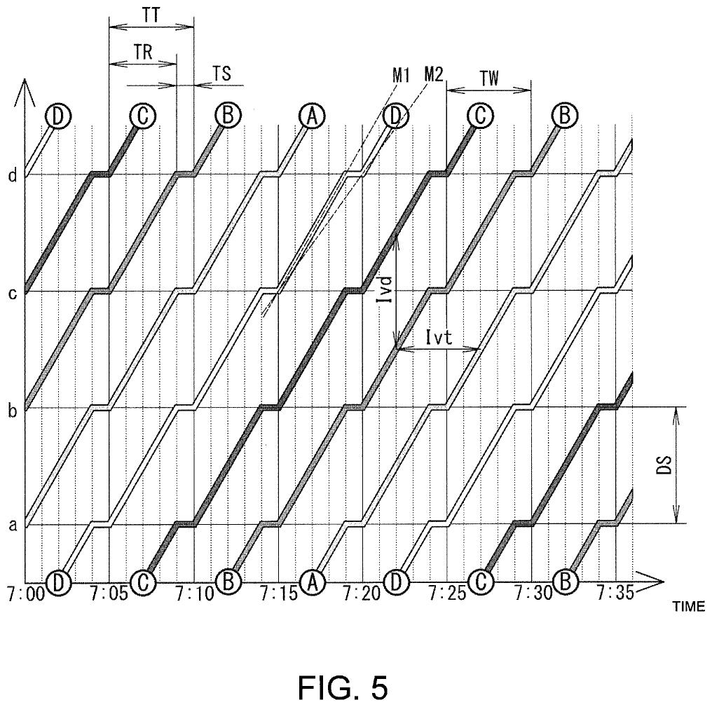

Each vehicle 52 runs autonomously in accordance with the received travel plan 80. FIG. 5 is an operation timing chart for each of the vehicles 52A to 52D traveling autonomously in accordance with the travel plan 80 of FIG. 4. In FIG. 5, the horizontal axis and the vertical axis represents the time and the position of the individual vehicles 52. Before describing the travel of each vehicle 52, the meanings of various parameters used in the following description will be explained briefly.

In the following description, a distance from one station 54 to the next station 54 is referred to as an “inter-station distance DS”. Time from when the vehicle 52 departs one station 54 until reaching the next station 54 is referred to as “inter-station required time TT”, and time when the vehicle 52 stops at the station 54 for users to board and exit is referred to as “stopping time TS”. Furthermore, the time from leaving one station 54 to reaching the next station 54, i.e., the time obtained by subtracting the stopping time TS from the inter-station required time TT, is referred to as “inter-station travel time TR”. The circled number in FIG. 4 illustrates the inter-station required time TT.

Furthermore, the value obtained by dividing the traveled distance by the travel time including the stopping time TS is referred to as “scheduled speed VS”, and the value obtained by dividing the traveled distance by the travel time not including the stopping time TS is referred to as an “average travel speed VA”. The slope of line M1 in FIG. 5 represents the average travel speed VA, and the slope of line M2 in FIG. 5 represents the scheduled speed VS. The scheduled speed VS is inversely proportional to the inter-station travel time TT

As mentioned above, the operation interval calculated by the operation monitoring unit 18 can be a temporal interval or a distance interval. The temporal interval is the interval of time between two vehicles 52 passing through the same position, e.g., an interval Ivt in FIG. 5. The distance interval is the interval of distance between the two vehicles 52 at the same time, e.g., an interval Ivd in FIG. 5. The number enclosed in a square in FIG. 4 represents the temporal operation interval.

Next, referring to FIG. 5, the operation of the vehicles 52 will be described. According to the travel plan 80 of FIG. 4, the vehicle 52A shall depart the station 54a at 7:00 and then depart the station 54b five minutes later at 7:05. The vehicle 52A controls its average travel speed VA so that it can complete the movement from the station 54a to the station 54b and the boarding and exiting of users during the 5-minute period.

Specifically, the vehicle 52 stores in advance a standard stopping time TS required for boarding and exiting of users as a planned stopping time TSp. The vehicle 52 then subtracts the planned stopping time TSp from the time of departure at the station 54 determined by the travel plan 80 to calculate a target time to reach the station 54 in question. For example, if the planned stopping time TSp is 1 minute, the target time for the vehicle 52A to reach the station 54b is 7:04. The vehicle 52 controls its travel speed so that it can reach the next station 54 by the calculated target time

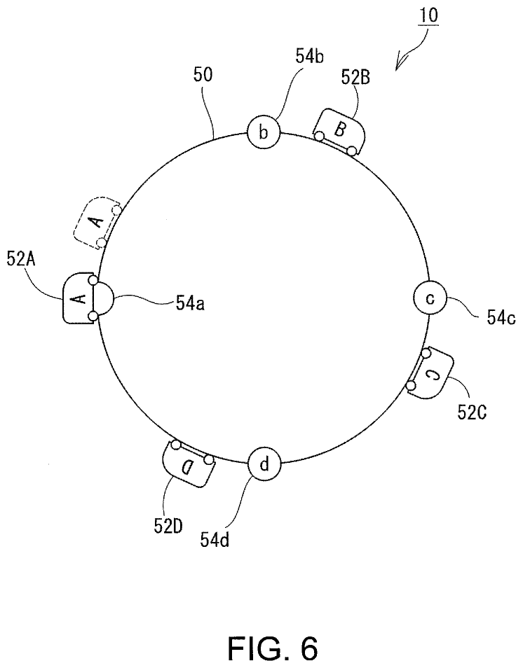

Because of traffic congestion on the travel route 50, an increase in the number of users, and the like, some or all vehicles 52 may be delayed relative to the travel plan 80. For example, consider the case where the vehicle 52A is delayed. FIG. 6 illustrates a conceptual diagram in the case of a single vehicle 52A delayed. In FIG. 6, a dashed line represents the ideal position of the vehicle 52A. It is clear from FIG. 6 that when one vehicle 52A is delayed, the operation interval between the delayed vehicle 52A and the preceding vehicle 52B is widened, and the operation interval between the delayed vehicle 52A and the trailing vehicle 52D is narrowed. In other words, due to the delay, a gap is created between the actual operation interval and the target operation interval (hereinafter referred to as an “interval error”).

The plan generation unit 14 attempts to solve the interval error if a delay occurs exceeding a certain level. There are several kinds of possible methods for solving the interval error. For example, in the example in FIG. 6, the interval error can be solved by temporarily accelerating the delayed vehicle 52A, or by decelerating vehicles 52B to 52D other than the delayed vehicle 52. Which solving method is more appropriate depends on the number of the vehicles 52, N, and thus the distance between the vehicles.

Therefore, the plan generation unit 14 in this example prepares a plurality of solving policies that specify how to solve the interval error, and if a delay occurs exceeding a certain level, at least one solving policy is selected in accordance with the number of the vehicles 52, N. Then, the plan generation unit 14 generates the travel plan 80 according to the selected policy, which is described in detail below

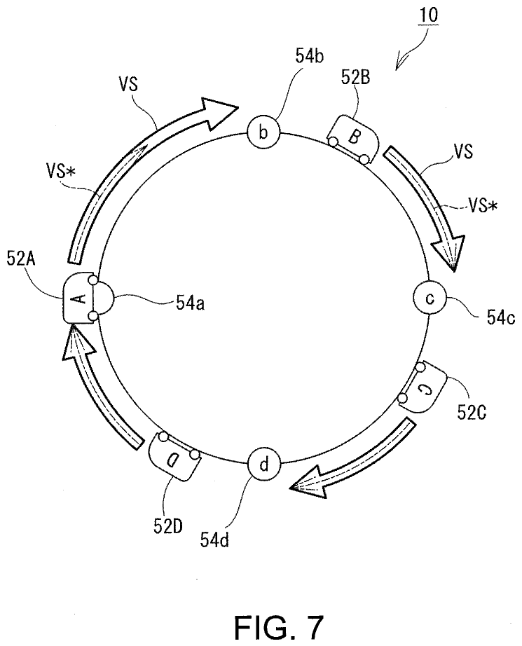

First, the solving policy of the plan generation unit 14 will be described. The plan generation unit 14 in this example includes a first solving policy and a second solving policy. The first solving policy solves the interval error on the travel plan 80 without decelerating any vehicle 52 below a standard surface speed VS*. FIG. 7 illustrates a conceptual diagram of the first solving policy. In FIG. 7, the white arrows represent the scheduled speed VS of each vehicle 52, and the single-dotted arrows represent the standard scheduled speed VS*. Here, the standard scheduled speed VS* is the standard speed VS which has been scheduled and determined as the standard scheduled speed set for each vehicle 52 before the delay occurs. In the example in FIG. 4, the standard scheduled speed VS* is the speed at which the inter-station travel time TT is 5 minutes

Assume that for some reason, as illustrated in FIG. 7, the vehicle 52A is delayed relative to the travel plan 80, and the distance between the delayed vehicle 52A and the preceding vehicle 52B increases, and the distance between the delayed vehicle 52A and the trailing vehicle 52D decreases. To solve the interval error, the first solving policy decelerates none of the vehicles 52 and temporarily accelerates the delayed vehicle 52A above the standard scheduled speed VS*. This causes the operation interval between the vehicles 52 to match the predetermined target operation interval and allows the vehicles to return to the equal interval operation.

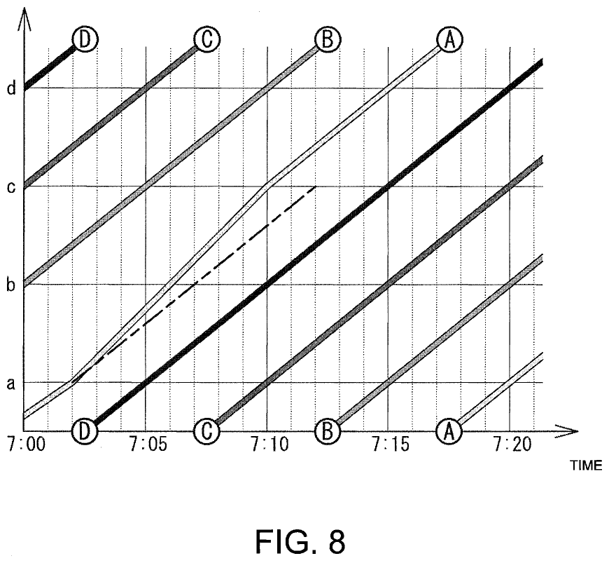

FIG. 8 is an operation timing chart for the vehicle 52 when the first solving policy is followed. In FIG. 8, there is no stopping time TS illustrated for each vehicle 52 to facilitate understanding of the scheduled speed VS of each vehicle 52. In this case, the slope of the operation line of each vehicle 52 represents the scheduled speed VS. Also, in FIG. 8, the slope of the single-dotted line represents the standard scheduled speed VS*.

In the example in FIG. 8, the vehicle 52A departs the station 54a at 7:02, two minutes later than in the travel plan 80, causing the intervals between the operations of the vehicles 52 to be uneven. To solve the unevenness of the operation intervals, and thus the interval error, the delayed vehicle 52A is temporarily accelerated above the standard scheduled speed VS* in the example in FIG. 8. As a result, at 7:10, when the delayed vehicle 52A departs the station 54c, the unevenness in the intervals of the operations is solved and the vehicles can return to the equal interval operation.

Here, the travel plan 80 may or may not be modified in order to temporarily accelerate the delayed vehicle 52A. In other words, the travel plan 80 in the absence of delay has its departure timing specified so that all vehicles 52A to 52D can travel at the standard scheduled speed VS*, as illustrated in FIG. 4. If the vehicle 52A is delayed, the delayed vehicle 52A attempts to accelerate so as to operate in accordance with the travel plan 80 without modifying the travel plan 80. For example, assume that the vehicle 52A departs the station 54a at 7:02 for some reason. In this case, if the travel plan 80 is not modified, the delayed vehicle 52A needs to depart the station 54b at 7:05. In this case, the travel time TT is 3 minutes, and the vehicle should travel at an accelerated speed faster than the standard scheduled speed VS* (i.e., the speed at which the inter-station required time TT of 5 minutes is achieved). Therefore, without modifying the travel plan 80, the delayed vehicle 52A can run at a temporarily accelerated speed faster than the standard scheduled speed VS* to meet the travel plan 80.

Thus, when the first solving policy is selected, the plan generation unit 14 does not normally generate a dedicated travel plan 80 for solving the interval error, even if a delayed vehicle occurs, but generates a similar travel plan 80 at the same timing as in the case of no delay. Exceptionally, if all vehicles 52A to 52D are delayed, the plan generation unit 14 generates a rescheduled travel plan 80 in accordance with the smallest delay vehicle in which the delay amount DL is minimum, to enable all vehicles 52A to 52D to travel at the standard scheduled speed VS*. For example, assume that the vehicle 52A is delayed by 2 minutes and the vehicles 52B to 52D are delayed by 1 minute. In this case, the plan generation unit 14 regenerates the travel plan 80 with all the departure times recorded in the pre-modified travel plan 80 being postponed by one minute.

In any case, according to the first solving policy, none of the vehicles 52 are decelerated, so that an increase in travel time and waiting time for users of each vehicle 52 is effectively prevented.

It is noted that the first solving policy requires that the delayed vehicle 52A be able to accelerate faster than the standard listed speed VS*. However, it may be difficult for the delayed vehicle 52A to accelerate, depending on the delay situation. In other words, it is necessary to increase the average travel speed VA or to reduce the stopping time TS, in order to increase the scheduled speed VS, but it is difficult to increase the average travel speed VA depending on the road conditions or the traffic congestion in the travel route 50. In addition, when the inter-station distance DT is short, it is difficult to significantly reduce the travel time, even if the average travel speed VA is increased. Although it is effective to shorten the stopping time TS to increase the scheduled speed VS, the gap between the vehicle 52A and the preceding vehicle 52B is widened in the case of the delayed vehicle 52A, and the waiting time of the delayed vehicle 52A at each station 54 is longer. The longer the waiting time, the more people are waiting to board the delayed vehicle 52A at the station in question. Also, if there are many people waiting, it is difficult to shorten the stopping time TS because it takes more time for boarding and exiting. In some cases, the stopping time TS is longer than the planned stopping time TSp, which may further increase the delay.

Thus, if the delayed vehicle 52A cannot accelerate, the first solving policy cannot solve the interval error. Therefore, the plan generation unit 14 includes a second solving policy in addition to the first solving policy. The second solving policy is a policy to solve the interval error by temporarily decelerating at least some of the vehicles 52 below the standard surface speed VS*. The second solving policy is further divided into a second solving policy A and a second solving policy B

If the second solving policy A is selected, the plan generation unit 14 reschedules the travel plan 80 with respect to the vehicle with the largest delay AD. At the same time, the plan generation unit 14 causes the vehicle with the largest delay to travel at the standard scheduled speed VS* on the travel plan 80, and temporarily decelerates the vehicles 52 other than the vehicle with the largest delay 52 below the standard scheduled speed VS*.

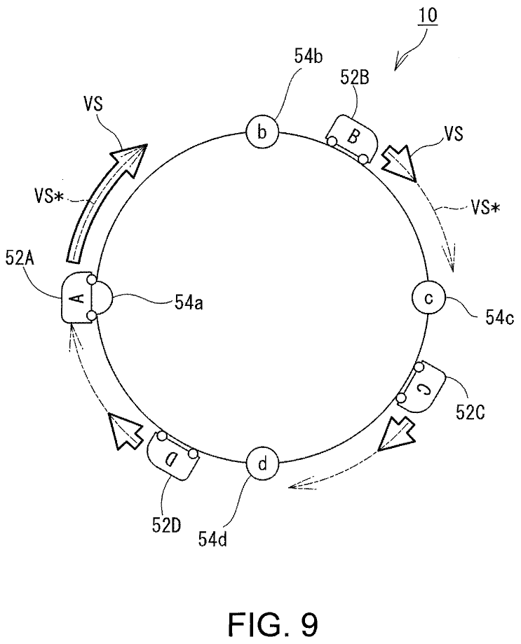

FIG. 9 illustrates a conceptual diagram of the second solving policy A. Again, in FIG. 9, the white arrows and the single-dotted arrows respectively represent the scheduled speed VS and the standard scheduled speed VS* of each vehicle 52. In FIG. 9, only the vehicle 52A is delayed and the other vehicles 52B to 52D are not delayed. The second solving policy A causes the vehicle 52A, which is the vehicle with the largest delay, to travel at the standard scheduled speed VS*, and temporarily decelerates the other vehicles 52B to 52D below the standard scheduled speed VS*. Here, the deceleration of the scheduled speed VS can be easily achieved by increasing the stopping time TS at the stations 54. In other words, the second solving policy A can reliably solve the interval error regardless of the road conditions, the traffic congestion, the number of waiting passengers, and the like

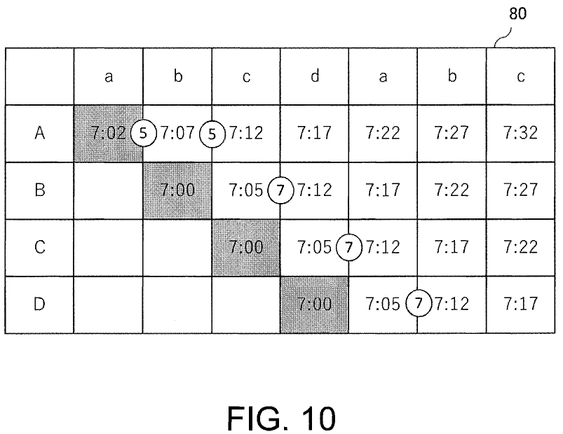

FIG. 10 illustrates an example of a regenerated travel plan 80 according to the second solving policy A. Assume that each vehicle 52 has been traveling in accordance with the travel plan 80 of FIG. 4, but the vehicle 52A has departed the station 54a at 7:02, two minutes late, for some reason. When the delay of the vehicle 52A is detected, the plan generation unit 14 reschedules the travel plan 80 of the vehicle 52A with respect to the current position of the vehicle 52A. That is, the departure times of the vehicle 52A at the stations 54b, 54c, and 54d are changed from 7:02 to 7:07, 7:12, and 7:17, which are 5, 10, and 15 minutes after 7:02, respectively.

In connection with the change in the travel plan 80 for the vehicle 52A, the travel plan 80 for the other vehicles 52B to 52D is also changed. Specifically, in the example in FIG. 4, the vehicles 52B, 52C, and 52D are planned to depart the stations 54d, 54a, and 54b, respectively, at 7:10, but if a delay is detected, the travel plan 80 is changed so that the vehicles can depart at 7:12. As a result, the vehicles 52B to 52D each have an inter-station travel time TT of 7 minutes temporarily, and their scheduled speed VS is slower than the standard scheduled speed VS*

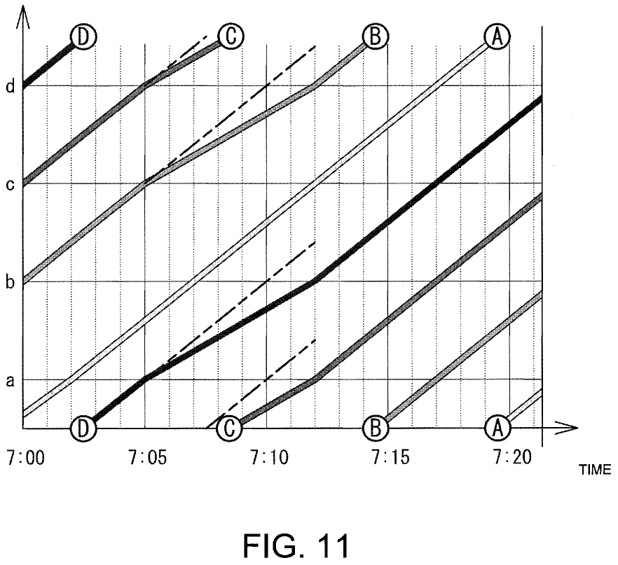

FIG. 11 is a timing chart for the operation of the vehicles 52 when the second solving policy A is followed. Again, in FIG. 11, the stopping time TS for each vehicle 52 is set to zero, and the slope of the single-dotted line represents the standard scheduled speed VS*.

In the example of FIG. 11, the vehicle 52A departs the station 54a at 7:02, which is two minutes later than the travel plan 80. To eliminate the interval error caused by the delay, in the example in FIG. 11, the other vehicles 52B to 52D, other than the delayed vehicle 52A, are temporarily decelerated from the standard scheduled speed VS*. As a result, the unevenness of the intervals between operations is solved at 7:12, and the vehicles can return to the equal interval operation. Thus, the second solving policy A can solve the interval error reliably, even when the delayed vehicle 52 does not accelerate.

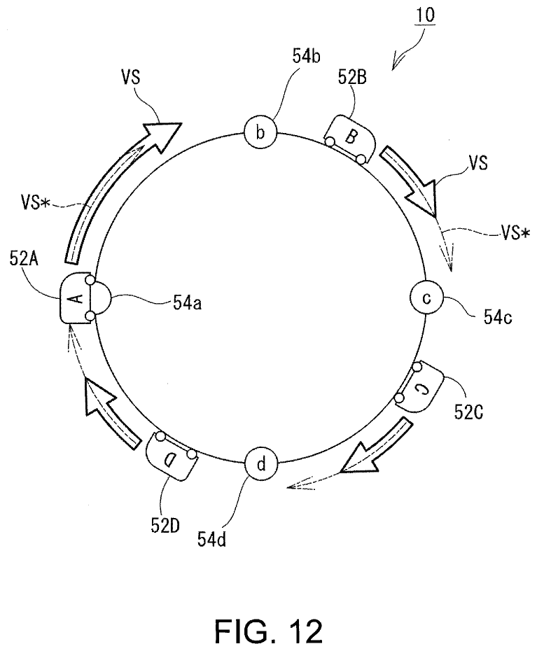

Next, the second solving policy B is described with reference to the drawings. The second solving policy B reschedules the travel plan 80 with respect to the current travel plan 80 to equalize the delay amount DL of the vehicles 52. FIG. 12 is a conceptual diagram of the second solving policy B. Again, in FIG. 12, the white arrows and the single-dotted arrows respectively represent the scheduled speed VS and the standard scheduled speed VS* of each vehicle 52.

In the second solving policy B, all vehicles 52A to 52D are delayed by a certain amount relative to the pre-delay travel plan 80. Here, a delay amount DL* granted to all vehicles 52A to 52D is calculated in accordance with the delay amount DL of multiple vehicles 52. For example, the delay amount DL* to be granted may be one-half of the delay amount DL of the vehicle with the largest delay 52A where the delay amount DL is maximum. The delay amount DL* to be granted may be an average of the delay amount DL of the largest delay vehicle 52 and the delay amount DL of the smallest delay vehicle 52 in which the delay amount DL is minimum (or there is no delay). Furthermore, the delay amount DL* granted may be an average of the delay amount DL of all vehicles 52.

In any case, equalizing the delay amount DL reduces the delay amount DL of the delayed vehicle 52A and increases the delay amount DL of the other vehicles 52B to 52D. In other words, the second solving policy B accelerates some vehicles 52 above the standard scheduled speed VS*, and decelerates the other vehicles 52 below the standard scheduled speed VS*

Here, it is clear from the comparison between FIG. 12 and FIG. 7 that the amount of acceleration of the delayed vehicle 52A is smaller with the second solving policy B than with the first solving policy. Therefore, the second solving policy B is more easily adopted when a significant acceleration of the delayed vehicle 52A is difficult to achieve. It is also clear from the comparison between FIG. 12 and FIG. 9 that the deceleration of the other vehicles 52B to 52D is smaller with the second solving policy B than with the second solving policy A. Therefore, the second solving policy B can minimize the increase in travel time and waiting time for users of the other vehicles 52B to 52D

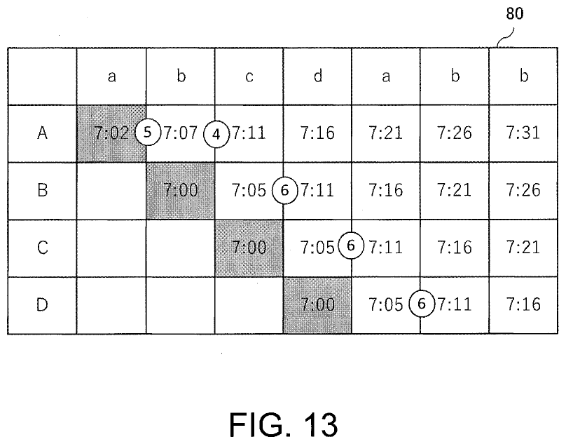

FIG. 13 illustrates an example of a regenerated travel plan 80 according to the second solving policy B. Assume that each vehicle 52 has been traveling in accordance with the travel plan 80 of FIG. 4, but the vehicle 52A has departed the station 54a at 7:02, two minutes late for some reason. When the delay of the vehicle 52A is detected, the plan generation unit 14 generates a new travel plan 80 to equalize the delay amount DL of the vehicles 52A to 52D relative to the travel plan 80 of FIG. 4. In the example of FIG. 13, all vehicles 52A to 52D are rescheduled so that all vehicles 52A to 52D can be delayed by one minute relative to the travel plan 80 of FIG. 4 after the time at which the vehicle 52A departs the station 54c (i.e., after 7:11). In this case, the delayed vehicle 52A is temporarily accelerated just before 7:11 so that the inter-station travel time TT can be 4 minutes, and the other vehicles 52B to 52D are temporarily decelerated so that the inter-station travel time TT can be 6 minutes.

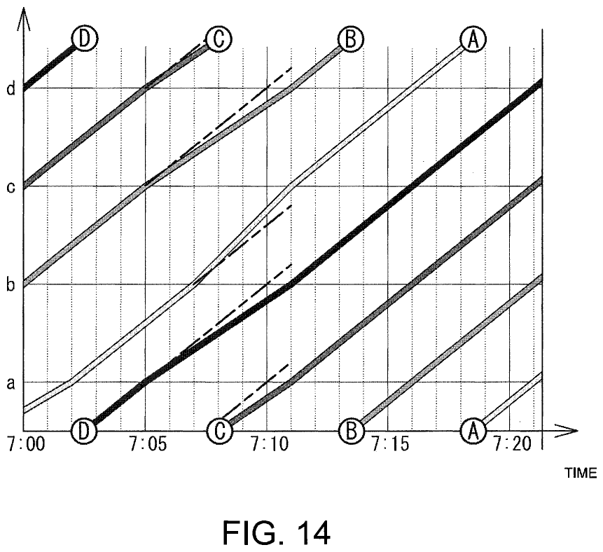

FIG. 14 is a timing chart for the operation of the vehicles 52 when the second solving policy B is followed. Again, in FIG. 14, the stopping time TS for each vehicle 52 is set to zero, and the slope of the single-dotted line represents the standard scheduled speed VS*.

In the example in FIG. 14, the vehicle 52A has departed the station 54a at 7:02, which is two minutes later than the travel plan 80. To eliminate the interval error caused by the delay, in the example in FIG. 14, the delayed vehicle 52A is temporarily accelerated above the standard scheduled speed VS*, and the other vehicles 52B to 52D are temporarily decelerated below the standard scheduled speed VS*. As a result, at 7:11, the unevenness of the intervals between operations is solved and the vehicles can return to the equal interval operation. Thus, the second solving policy B can solve the interval error while minimizing the speed change of each vehicle 52.

In this example, the solving policy used to solve the interval error is selected in accordance with the number of the vehicles 52, N, of the fleet. The reason for using the number of vehicles 52, N, as a criterion is that the number of vehicles N has a significant effect on the waiting time for users at the stations 54, the probability of increasing the interval error, and the like.

For example, the smaller the number of vehicles 52, N, the longer the distance between the vehicles, and the longer the departure interval of the vehicles 52 at each station 54. In the example in FIG. 1, for example, if the number of the vehicles 52, N, is 4, the distance between the vehicles is one-station, and the interval between the departures of the vehicles 52 from each station is 5 minutes. On the other hand, if the number of the vehicles, 52, N, is 2, the distance between the vehicles is two-stations, and the interval between the departures of the vehicles 52 from each station is 10 minutes. Therefore, if some of the vehicles 52 are delayed when the number of the vehicles 52, N, is small, the waiting time for the delayed vehicles 52 at the stations 54 can easily expand to an unacceptable length of time. On the other hand, if some vehicles 52 are delayed when the number of the vehicles 52, N, is large, the waiting time for the delayed vehicles 52 at the stations 54 would not expand to an unacceptable length of time.

Therefore, when the number of the vehicles 52, N, is not more than a predetermined reference number of vehicles Ndef, the plan generation unit 14 generates the travel plan 80 in accordance with the second solving policy to reliably solve the interval error. On the other hand, if the number of the vehicles 52, N, exceeds the reference number Ndef, the plan generation unit 14 selects the first solving policy to avoid the deceleration of the vehicles 52, which is the cause of the increase of the travel time for users, as much as possible. The reference number Ndef is predetermined in accordance with the past operation history and other factors of the transportation system 10.

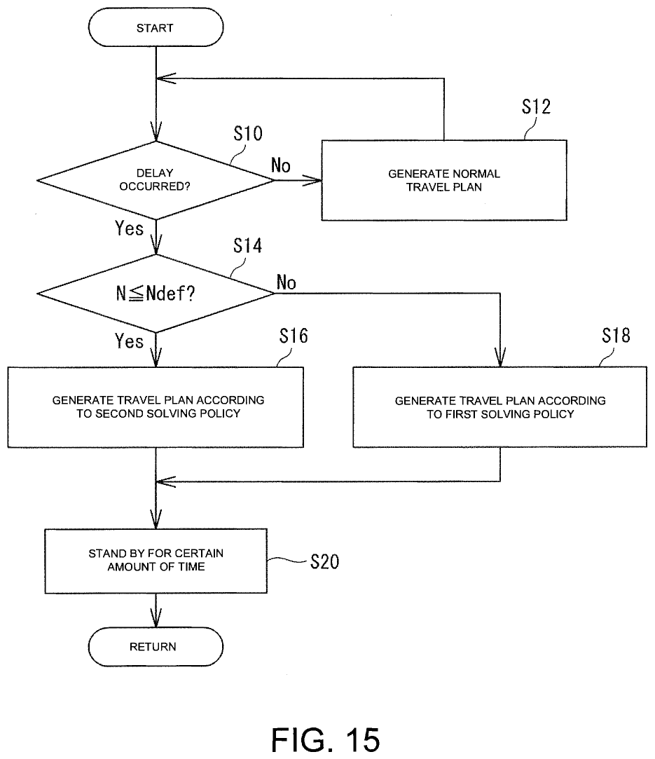

FIG. 15 is a flowchart illustrating the process flow of the plan generation unit 14. The plan generation unit 14 monitors the occurrence of delays above a certain level (S10). That is, the plan generation unit 14 periodically obtains the delay amount DL of each vehicle 52 from the operation monitoring unit 18, and compares the delay amount DL with a predetermined allowable delay amount DLmax. As a result of the comparison, if the delay amount DL is smaller than the allowable delay amount DLmax (No in S10), the plan generation unit 14 determines that there is no delay, and generates and sends a normal travel plan 80 (S12).

On the other hand, if the delay amount DL is equal to or larger than the allowable delay amount DLmax (Yes in S10), the plan generation unit 14 compares the number of the vehicles 52, N, constituting the fleet, and the reference number Ndef (S14). As a result of the comparison, if N Ndef (Yes in S14), the plan generation unit 14 generates the travel plan 80 according to the second solving policy (S16). The generated travel plan 80 is transmitted to each vehicle 52 via the communication device 16

The second solving policy includes a second solving policy A and a second solving policy B, as described above. The second solving policy in step S16 may be the second solving policy A or the second solving policy B. Thus, in step S16, the plan generation unit 14 may generate the travel plan 80 that temporarily decelerates the vehicles 52 other than the largest delay vehicle 52, or may generate the travel plan 80 that equalizes the delay amount DL of all vehicles 52. In step 16, the plan generation unit 14 may select one solving policy from the second solving policy A and the second solving policy B in accordance with the number of the vehicles 52, N, and the like.

On the other hand, if N>Ndef (No in S14), the plan generation unit 14 generates the travel plan 80 according to the first solving policy (S18). The first policy can effectively prevent the prolonged travel time, because none of the vehicles 52 are decelerated.

Once the travel plan 80 is generated according to the solving policy, the plan generation unit 14 stands by for a certain amount of time (S20). This is because it takes a certain amount of time after sending the regenerated travel plan 80 before the delay of the vehicle 52 is actually solved. After standing by for a certain amount of time, the plan generation unit 14 returns to step S10 and repeats the process of steps S10 to S20.

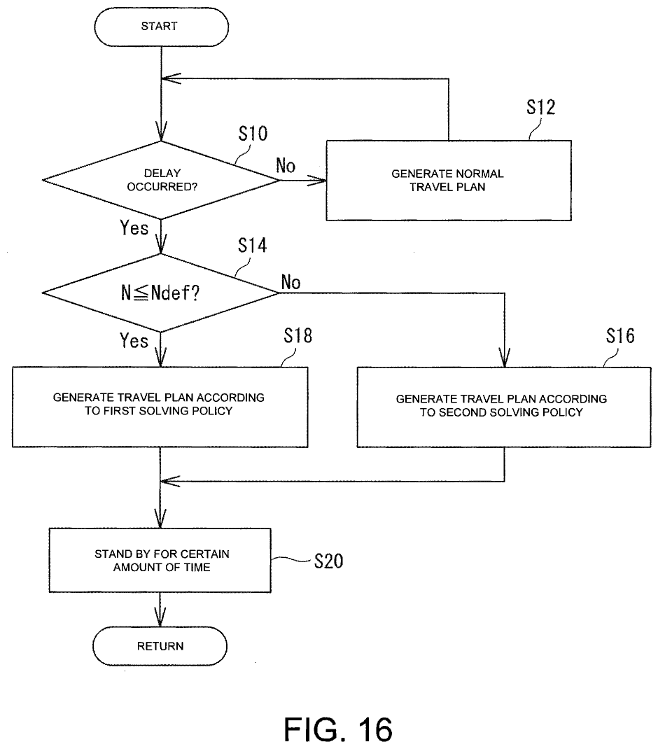

Next, another example of the process flow of the plan generation unit 14 will be described. In the flowchart of FIG. 16, the solving policy is selected by taking into account the probability of solving the delay. That is, in general, the higher the number of the vehicles 52, N, the higher the transportation demand (i.e., the higher the number of users). The higher the transportation demand, the higher the increase in the number of people waiting at the stations 54 per unit of time. Therefore, the delay, and thus the interval error, once it occurs, is more difficult to solve as the transportation demand is higher. For example, assume that the number of the vehicles 52, N, is 2, the transportation demand is low, and the number of people waiting at each station 54 increases by one person per minute, and also assume that the number of the vehicles 52, N, is 4, the transportation demand is high, and the number of people waiting at each station 54 increases by two persons per minute. In this case, for the same one-minute delay, the number of waiting people that increases due to the delay is one person when N=2, but when N=4, the number of waiting people that increases is two persons. When the number of waiting people increases, the boarding and exiting time (and hence the stopping time) at each station 54 is also likely to increase, thus increasing the possibility of unsolved delay or expanded delay.

Therefore, when considering the probability of solving the delay, it is necessary to take measures that can solve the delay (or interval error) more reliably when the number of the vehicles 52, N, is larger. In the flowchart of FIG. 16, if the number of the vehicles 52, N, is not more than the reference number Ndef (Yes in S14), the plan generation unit 14 generates the travel plan 80 according to the first solving policy (S18). On the other hand, if the number of the vehicles 52, N, is larger than the reference number Ndef (No in S14), the plan generation unit 14 generates the travel plan 80 in accordance with the second solving policy (S16). Such a configuration can quickly eliminate the delay when the transportation demand is high and the delay is likely to increase, while preventing the prolonged travel time when the transportation demand is low and the delay is unlikely to increase.

As heretofore described, the solving policy is only determined in accordance with the number of vehicles 52, N, but the solving policy may be determined by considering other factors in addition to the number of vehicles N. For example, in addition to the number of vehicles N, the solving policy may be determined by considering at least one of the passenger information 84 transmitted from the vehicles 52 and the waiting passenger information 86 transmitted from the station terminal 70. The plan generation unit 14 may, for example, estimate the boarding and exiting time of the largest delay vehicle 52 in accordance with at least one of the passenger information 84 and the waiting passenger information 86. In accordance with the estimated boarding and exiting time and the number of the vehicles 52, N, the plan generation unit 14 may calculate a risk of increase in delay R, and may select the solving policy in accordance with the risk of increase in delay R.

More specifically, the passenger information 84 indicates the number and attributes of the passengers in the vehicle 52, as described above, and is obtained, for example, by analyzing an image taken of the interior of the vehicle 52. The number and attributes of these passengers are parameters that have a significant impact on the exiting time at each station 54. For example, the higher the number of the passengers, the longer the exiting time at each stations 54 and the longer the vehicle 52 stops for. In addition, the use of wheelchairs, white canes, braces, and strollers is likely to result in longer exiting time compared to the case where they are not used. Younger infants and older adults are also more likely to take longer to exit the vehicle than other passengers.

Therefore, the plan generation unit 14 may predict the exiting time, and hence the stopping time at each station 54 for the vehicle 52 according to the number and attributes of the passengers of the vehicle 52. The method of the prediction is not particularly limited, but, for example, the exit time may be identified for each passenger according to their attributes, and an accumulated value may be calculated as the exit time for all vehicles 52.

The waiting passenger information 86 is sent from the station terminal 70 and indicates the number and attributes of the waiting passenger information 86 waiting for the vehicles 52 at the stations. The waiting passenger information 86 may be transmitted from the station terminal 70 to the operation management device 12 multiple times regularly. Such a configuration enables the operation management device 12 to ascertain changes in the number and attributes of the waiting passengers over time. The plan generation unit 14 may predict the boarding time at each station 54 in accordance with the number and attributes of the waiting passengers. The method of the prediction is not limited, but may, for example, periodically estimate the boarding time at the station in question in accordance with the number and attributes of the waiting passengers, and calculate a rate of increase in the boarding time per unit of time. With the calculated rate of increase, the boarding time of the waiting passengers at the time the vehicle 52 reaches the station 54 may be calculated.

In any case, the plan generation unit 14 estimates the boarding and exiting time of the largest delay vehicle 52 at each station 54 in accordance with at least one of the predicted exiting time from the passenger information 84 and the boarding time predicted from the waiting passenger information 86. The plan generation unit 14 calculates the risk of increase in delay R in accordance with the boarding and exiting time and the number of the vehicles 52, N. The method of calculating the risk of increase in delay R is not limited, but the longer the boarding and exiting time and the larger the number of the vehicles 52, N, the higher the risk of increase in delay R. For example, assuming that the predicted boarding and exiting time divided by the predetermined planned stopping time TSp is P1, and the number of the vehicles 52, N, divided by the predetermined reference number of the vehicles is P2, and predetermined coefficients are K1, K2, then the risk of increase in delay R may be calculated according to the formula R=K1*P1+K2*P2.

The plan generation unit 14 selects the solving policy in accordance with the calculated risk of increase in delay R. For example, if the risk of increase in delay R is small, the first solving policy that does not decelerate the vehicle 52 may be selected, and if the risk of increase in delay R is large, the second solving policy that more reliably eliminates the delay may be selected.

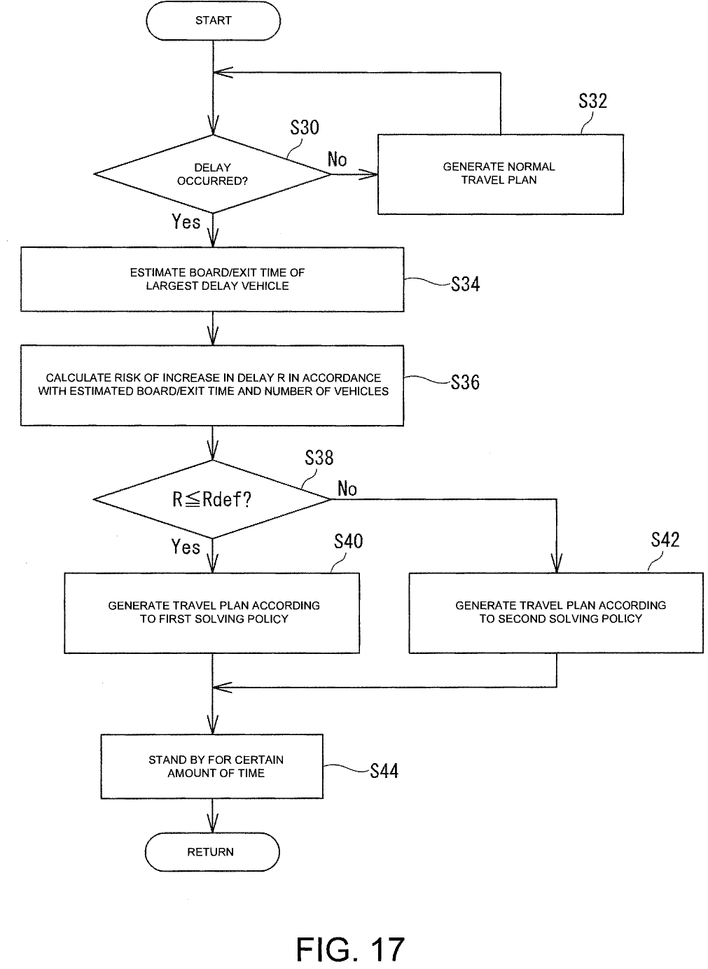

FIG. 17 is a flowchart illustrating the process flow of the plan generation unit 14 in the case of selecting the solving policy in accordance with the risk of increase in delay R. As illustrated in FIG. 17, when a delay exceeding a certain level occurs (Yes in S30), the plan generation unit 14 estimates the boarding and exiting time of the largest delay vehicle 52 in accordance with at least one of the passenger information 84 and the waiting passenger information 86 (S34). The plan generation unit 14 then calculates the risk of increase in delay R in accordance with the estimated boarding and exiting time and the number of vehicles 52, N. (S36).

When the risk of increase in delay R is calculated, the plan generation unit 14 compares the risk of increase in delay R with a predetermined reference risk Rdef (S38). As a result of the comparison, if the risk of increase in delay R is small (Yes in S38), avoiding the increase in the travel time and the waiting time is prioritized over recovering the delay (and thus eliminating the interval error). Therefore, in this case, the plan generation unit 14 generates the travel plan 80 according to the first solving policy that does not decelerate any vehicle 52 (S40).

On the other hand, if the risk of increase in delay R exceeds the reference risk R (No in S38), the plan generation unit 14 prioritizes the recovery of the delay and thus the solving of the interval error. Therefore, in this case, the plan generation unit 14 generates the travel plan 80 according to the second solving policy of decelerating some vehicles 52 on the travel plan 80.

After generating the travel plan 80, the plan generation unit 14 stands by for a certain amount of time (S44), returns to step S30 again, and then repeats the same process.

As is clearly described in the above, the solving policy is selected in this example in accordance with at least one of the passenger information 84 and the waiting passenger information 86, as well as the number of the vehicles 52, N. Thus, a more appropriate solving policy can be selected according to the situation.

The configuration described heretofore is merely an example, and other elements of the configuration can be changed as appropriate if at least one solving policy is selected from among two or more solving policies when a delay occurs in accordance with the number of vehicles 52, N, that constitute the fleet, and the travel plan 80 is generated according to the selected solving policy. For example, the operation management device 12 may include a solving policy other than the solving policies described above. The solving policy may be selected by considering any factors other than those listed above if it is selected in accordance with at least the number of the vehicles 52, N. For example, the day of the week and time of the day, information on events in the vicinity of the stations, information on traffic congestion in the travel route 50, and the reservation status of the vehicles 52, if available, may be used to select the solving policy. The number of and the size of intervals between the stations 54 and the vehicles 52 may be changed as appropriate. Although the travel plan 80 described heretofore specifies only the times of departure at the stations 54, the travel plan 80 may be in other forms. For example, the travel plan 80 may provide arrival times at the stations 54, an average travel speed VA of each vehicle 52, and the like, instead of or in addition to the departure times at the stations 54.

### REFERENCE SIGNS LIST

10 Transportation system

12 Operation management device

14 Plan generation unit

16 Communication device

18 Operation monitoring unit

20 Storage device

22 Processor

24 Input/Output device

26 Communication I/F

50 Travel route

52 Vehicle

54 Station

56 Autonomous driving unit

58 Drive unit

60 Autonomous driving controller

62 Environmental sensor

64 In-vehicle sensor

66 Position sensor

68 Communication device

70 Station terminal

72 In-station sensor

74 Communication device

80 Travel plan

82 Travel information

84 Passenger information

86 Waiting passenger information.

1. An operation management device, comprising:
a plan generation unit that generates a travel plan for each of a plurality of vehicles constituting a fleet and traveling autonomously along a predetermined travel route;
a communication device that transmits the travel plan to a vehicle handled by the travel plan and receives travel information from the vehicle indicating a traveling state of the vehicle; and
an operation monitoring unit that acquires a delay amount of the vehicle relative to the travel plan and an operation interval of the vehicles in accordance with the travel information, wherein
the plan generation unit includes two or more solving policies for solving an interval error which is a discrepancy between the operation interval of the vehicles and a predetermined target operation interval of the vehicles, and
in a case of occurrence of a delay exceeding a predetermined allowable delay amount, the plan generation unit selects a solving policy from among two or more solving policies in accordance with at least the number of vehicles that constitute the fleet, and generates the travel plan in accordance with the selected solving policy.

2. The operation management device according to claim 1, wherein
the two or more solving policies include
a first solving policy that solves the interval error on the travel plan without decelerating any vehicle below a standard scheduled speed which is a standard speed that has been scheduled, and
a second solving policy that solves the interval error on the travel plan by temporarily decelerating at least some of the vehicles below the standard scheduled speed.

3. The operation management device according to claim 2, wherein
the second solving policy includes a solving policy that solves the interval error by rescheduling the travel plan with reference to an actual position of a vehicle with the largest delay where the delay amount is maximum, and enables the vehicle with the largest delay to travel at the standard scheduled speed, while temporarily decelerating the other vehicles, except for the vehicle with the largest delay, below the standard scheduled speed.

4. The operation management device according to claim 2, wherein
the second solving policy includes a solving policy that solves the interval error by rescheduling the travel plan with respect to the current travel plan to equalize the delay amount of the vehicles.

5. The operation management device according to claim 2, wherein
the plan generation unit generates the travel plan according to the second solving policy when the number of vehicles is equal to or smaller than a predetermined reference number of vehicles, and generates the travel plan according to the first solving policy when the number of vehicles exceeds the reference number of vehicles.

6. The operation management device according to claim 2, wherein
the plan generation unit generates the travel plan according to the first solving policy when the number of vehicles is equal to or smaller than a predetermined reference number of vehicles, and generates the travel plan according to the second solving policy when the number of vehicles exceeds the reference number of vehicles.

7. The operation management device according to claim 2, wherein
the communication device receives at least one of two kinds of information: passenger information sent from the vehicle and concerning passengers of the vehicle, and waiting passenger information sent from a station terminal at a station on the travel route and concerning people waiting for the vehicle at the station, and
the plan generation unit selects one of the two or more solving policies in accordance with the number of vehicles and at least one of the passenger information and the waiting passenger information.

8. The operation management device according to claim 7, wherein
the plan generation unit estimates boarding and exiting time of the vehicle with the largest delay where the delay amount is maximum in accordance with at least one of the passenger information and the waiting passenger information, and calculates a risk of increase in delay, which is a risk that the delay increases, in accordance with the boarding and exiting time of the vehicle and the number of vehicles, and
the plan generation unit generates the travel plan according to the first solving policy when the risk of increase in delay is equal to or smaller than a predetermined reference risk, while generating the travel plan according to the second solving policy when the risk of increase in delay is larger than the reference risk.

9. An operation management method, comprising:
generating a travel plan for each of a plurality of vehicles constituting a fleet and traveling autonomously along a predetermined travel route;
transmitting the travel plan to a vehicle handled by the travel plan;
receiving travel information from the vehicle indicating a traveling state of the vehicle; and
acquiring a delay amount of the vehicle relative to the travel plan and an operation interval of the vehicles in accordance with the travel information, wherein
in a case of occurrence of a delay exceeding a predetermined allowable delay amount, the operation management method selects a solving policy from among two or more solving policies for solving an interval error, which is a discrepancy between the operation interval of the vehicles and a predetermined target operation interval of the vehicle, in accordance with at least the number of vehicles constituting the fleet, and generates the travel plan in accordance with the selected solving policy.

10. A transportation system, comprising:
a fleet including a plurality of vehicles traveling autonomously along a predetermined travel route; and
an operation management device that manages operations of the vehicles, wherein
the operation management device includes
a plan generation unit that generates a travel plan for each of the vehicles,
a communication device that transmits the travel plan to a vehicle handled by the travel plan and receives travel information from the vehicle indicating a traveling state of the vehicle, and
an operation monitoring unit that acquires a delay amount relative to the travel plan of the vehicle and an operation interval of the vehicles in accordance with the travel information,
the plan generation unit includes two or more solving policies for solving an interval error which is a discrepancy between the operation interval of the vehicles and a predetermined target operation interval of the vehicles, and
in ca ase of occurrence of a delay exceeding a predetermined allowable delay amount, the plan generation unit selects a solving policy from among two or more solving policies in accordance with at least the number of vehicles constituting the fleet, and generates the travel plan in accordance with the selected solving policy.
